(19) United States
(12) Patent Application Publication
(10) Pub. No.: US 2015/0257959 A1
(43) Pub. Date: Sep. 17, 2015

(54) ABDOMINAL SUPPORT APPARATUS

(71) Applicant: Potty Paddle LLC, Sierra Madre, CA (US)

(72) Inventor: Paul McGerald, Sierra Madre, CA (US)

(73) Assignee: Potty Paddle LLC, Sierra Madre, CA (US)

(21) Appl. No.: 14/212,484

(22) Filed: Mar. 14, 2014

(51) Int. Cl. A61G 13/12

(52) U.S. Cl. CPC A61G 13/1205; A61G 2200/50

(57) ABSTRACT

An abdominal support apparatus is adapted to engage a portion of a toilet seat or a toilet bowl. The abdominal support apparatus may include a wall member, a first lever member that may extend outwardly from the wall member, a lever handle member that may connect to the first lever member, a second lever member that may connect to and may extend outwardly from the lever handle member, and an interior member that may connect to and may extend downwardly from the second lever member. The wall member, the first lever member, the lever handle member, the second lever member, or the interior member may be integrally formed as a monolithic unit.

### FIELD OF THE INVENTION

The present invention relates to an abdominal support apparatus to be used by persons needing abdominal support when engaging in certain activities.

### BACKGROUND

At times, it may become necessary for a person to employ an abdominal support. Illnesses and medical procedures can cause a person's abdominal area to be weakened or strained. Certain activities may provide additional stress, strain, or pressure on the abdominal area of a person. Two such activities are defecation and urination. As such, it may be necessary or helpful to provide abdominal support through a device.

A typical device may provide abdominal support through a band, a strap, or a belt that can be fastened around a person's waist or abdominal area. Another typical device may be a type of diaper that may provide abdominal support through a band, a strap, or a belt around a person's waist or abdominal area. Many, if not all, abdominal support devices are designed to be worn by the user and are not designed to provide abdominal support to a person while defecating or urinating.

European Patent Application No. 88121799.6 by Kimberly-Clark Corporation discloses an anatomically form-fitting, generally self-adjusting disposable diaper that comprises an absorbent structure and an outer cover for positioning the absorbent structure against the body to absorb and contain body wastes. An abdominal support zone which corresponds to the lower abdominal area of the wearer spaced longitudinally away from the waist opening and extending across at least the central portion of the front panel, imparts a tensile stress thereto which is greater than that of the remaining front panel and waist opening. The device described in the '799.6 Kimberly-Clark Corporation patent application is more directed toward a diaper-like device than an abdominal support device and it applies a small amount of force to the abdominal area of a person which is not adequate to provide the necessary abdominal support for some persons. Additionally, the device provides little, if any, adjustability to the amount of force imposed upon the person's abdominal area.

U.S. Pat. No. 8,491,352 to Fong discloses a single piece garment for those having a distended abdomen, said garment extending upwards from the groin to beneath the breasts. The device described in the '352 patent comprises layers of elastomeric fabrics that provide abdominal support. The device, however, does not allow a person to defecate or urinate while it is employed. The device provides only a small amount of force to the abdominal area of a person which is not adequate to provide the necessary abdominal support for some persons. Additionally, the device provides little, if any, adjustability to the amount of force imposed upon the person's abdominal area.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to an abdominal support apparatus that advantageously allows for evacuation of waste from the human body while minimizing the pressure and stress to a user's abdominal area. The abdominal support apparatus according to an embodiment of the present invention may also advantageously provide support for the user's abdominal area and may provide negative pressure to a user's abdominal area (may provide pressure from an external source, the abdominal support apparatus, to negate the internal pressure created during defecation, urination, or other similar actions).

The embodiments of the present invention may advantageously permit a user to have leveraged and dynamic control of the volume of the abdominal cavity while simultaneously preventing pathological migration of abdominal and pelvic structures, such as tissue, during, for instance, evacuation of the bowels. In addition, the embodiments of the present invention may provide other benefits such as, for example, enhancing pressurization of the pelvic floor, rectum, and colon, reducing the frequency and amplitude of Valsalva straining efforts, reducing the risks of defecation syncope, shortening a defecation cycle, inhibiting “guarding reflexes” and signaling abdominal and/or pelvic muscles into a coordinated defecatory activity, awakening a “lazy” bowel due to jogging or gently jogging of the device, preventing and/or mitigating hernias, hemorrhoids, and constipation, fostering a sense of control in a user, acting as a source of bio-feedback which may be useful in bowel training exercises, and negating the need of elderly, infirm, and/or inflexible users to assume unachievable defecatory (“squat”) postures.

These and other objects, features and advantages of the present invention are provided by an abdominal support apparatus that may be adapted to engage a portion of a toilet seat, a toilet bowl, or other object or device. The abdominal support apparatus may include a wall member, a first lever member that may extend outwardly from the wall member, a lever handle member that may connect to the first lever member, a second lever member that may connect to and may extend outwardly from the lever handle member, and an interior member that may connect to and may extend downwardly from the second lever member. The wall member, the first lever member, the lever handle member, the second lever member, and the interior member may be integrally formed as a monolithic unit.

The abdominal support apparatus may include an angle between the first lever member and the second lever member extending outwardly from the lever handle member between at least 1° and 30°. The wall member may be generally square, rectangular, trapezoidal, circular, ovular, or polygonal. The wall member may include a top portion, a bottom portion, and opposing side portions. The bottom portion may be generally concave in the direction of the top portion. The wall member may further include a rounded edge and first and second opposing faces. The first lever member may be adjacent to the first opposing face and the second opposing face may include a projection. The projection may be a convex shape, a concentric shape, or a shape generally conforming to the contours of a human external abdominal area.

The lever handle member may be configured to function as a counterweight to the wall member. The interior member may include a first portion that may connect to the second lever member, a second portion that may connect to and may extend downwardly from the first portion, and a third portion that may connect to the second portion and may extend inwardly therefrom so that the third portion of the interior member may extend in a direction towards the lever handle member. The interior member may be configured to contact an interior portion of the toilet seat, an interior portion of the toilet bowl, or a portion of another object or device. Any of the first, second, and third portions may be curved.

The wall member may be positioned within a range from about 0° to about 45° away from a second axis defined as a vertical axis perpendicular to a first axis defined as a longitudinal axis of the first lever member. The lever handle member may include a passageway that may be formed through a body portion thereof and the passageway may be adapted to receive a handle member that may extend therethrough. The handle member may be formed of a metal, a wood, a fabric, a leather, a plastic, or a foam. The abdominal support apparatus may include a main lever member that may extend outwardly from the lever handle member and the first and second lever members may extend outwardly from the main lever member.

### BRIEF DESCRIPTION OF THE DRAWINGS

FIG. 1 is a perspective view of an abdominal support apparatus according to an embodiment of the present invention.

FIG. 2 is a side elevation view of the abdominal support apparatus of FIG. 1.

FIG. 3 is a top plan view of the abdominal support apparatus of FIG. 1.

FIG. 4 is a bottom plan view of the abdominal support apparatus of FIG. 1.

FIG. 5 is a front elevation view of the abdominal support apparatus of FIG. 1.

FIG. 6 is a rear elevation view of the abdominal support apparatus of FIG.

FIG. 7 is an environmental view of the abdominal support apparatus of FIG. 1 in use.

FIG. 8 is a perspective view of an abdominal support apparatus according to another embodiment of the present invention.

FIG. 9 is a side elevation view of the abdominal support apparatus of FIG. 8.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout, and prime notation is used to denote similar elements in alternative embodiments of the invention.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “front,” “back,” “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

Furthermore, in this detailed description, a person skilled in the art should note that quantitative qualifying terms such as “about” or “nearly” and other terms are used, in general, to mean that the referred to object, characteristic, or quality is close to the subject of the reference. More specifically, the term “about 180 degrees” is used, in general, to mean that the referred to amount of rotation or angle of rotation is nearly, close to, or mostly 180 degrees depending on the context, but could vary by less than one, one, or multiple degrees. Other similar terms may also be used in similar contexts, for example, and without limitation, “about 0 degrees.” The meaning of any of these terms is dependent upon the context within which it is used, and the meaning may be expressly modified.

In this detailed description of the present invention, a person skilled in the art should note that the term “torso” and phrase “abdominal area” and other like terms or phrases are used for the convenience of the reader in reference to the invention. The term “torso” and phrase “abdominal area” and other like terms or phrases are used in the broadest sense possible without losing the meaning intended herein. For example, and without limitation, the torso or abdominal area of a user would generally include the internal and external components of a user's lower upper body, including, but not limited to, the stomach, duodenum, gallbladder, liver, large and small intestines, external and internal abdominal oblique, rectus abdominis, tendinous inscriptions, transverse abdominis, and pubic symphysis.

An embodiment of the invention, as shown and described by the various figures and accompanying text, provides an abdominal support apparatus that may provide support for a user's abdominal area during evacuation of the user's bowels or bladder. The abdominal support apparatus may relieve stress, strain, or pressure on the user's abdominal area, provide support for the user's abdominal area, or provide negative pressure to a user's abdominal area (provide pressure from an external source to negate the internal pressure created during defecation, urination, or other similar actions) during these waste removing activities or other similar actions. The abdominal support apparatus may provide pressure on the abdominal area of a user in an inward, downward, and/or upward basis. The femoral canal may be sealed by the user folding his or her thighs against the wall member.

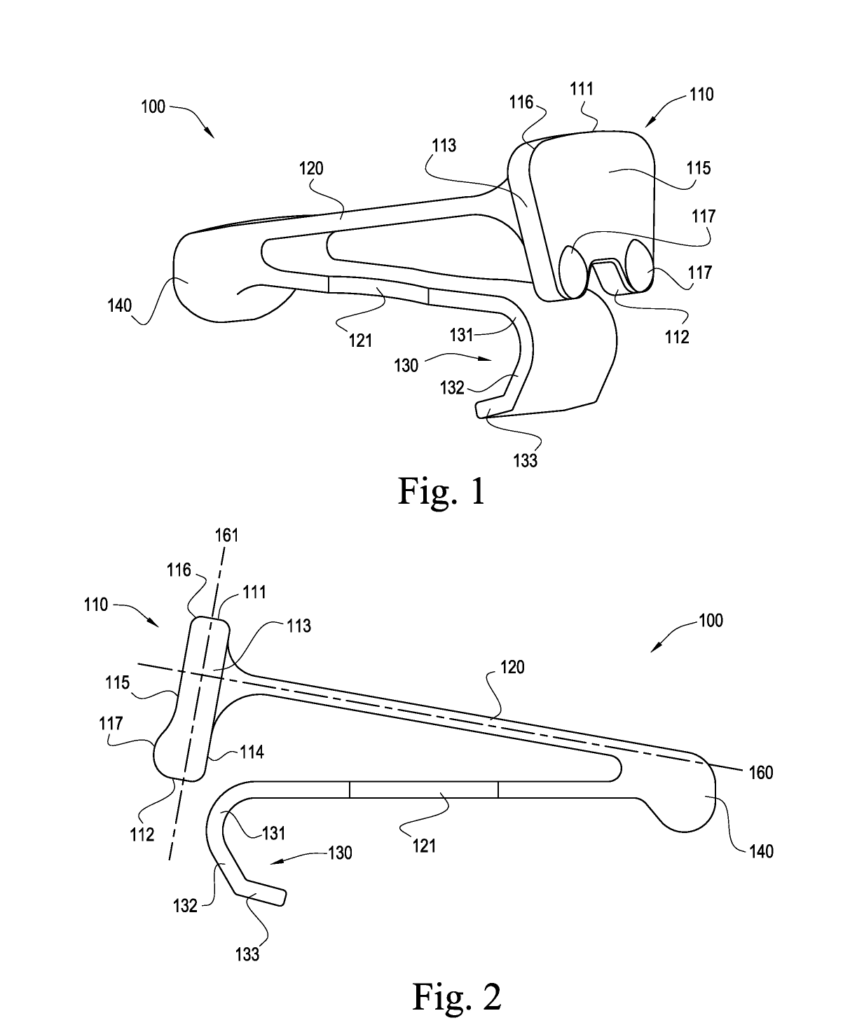

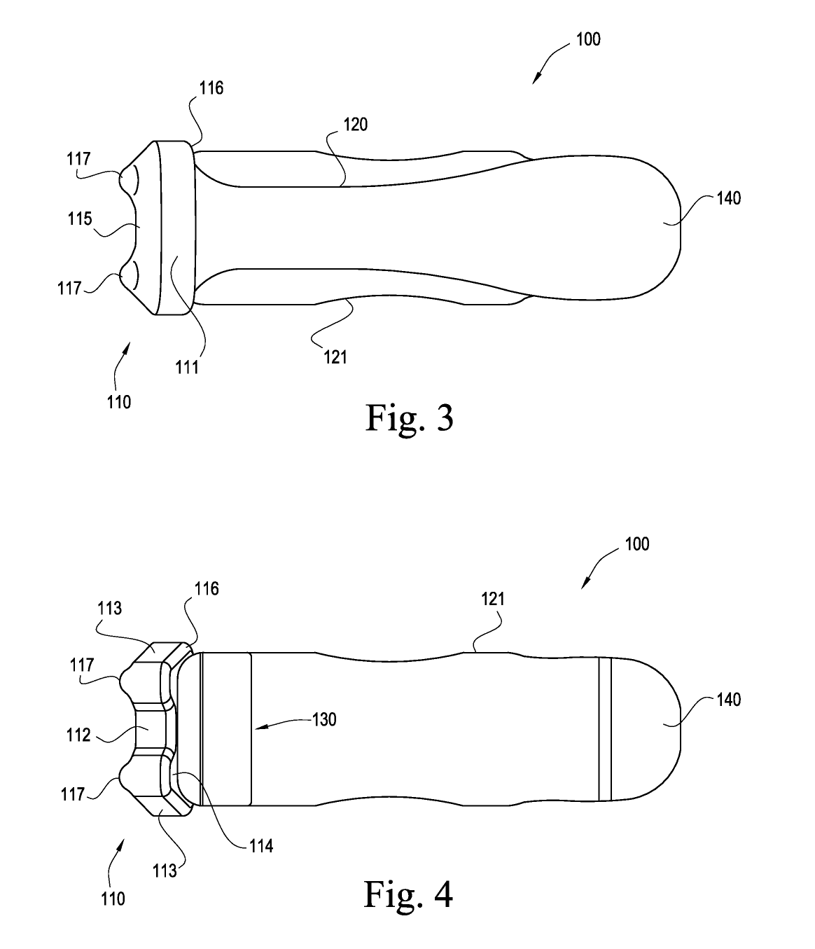

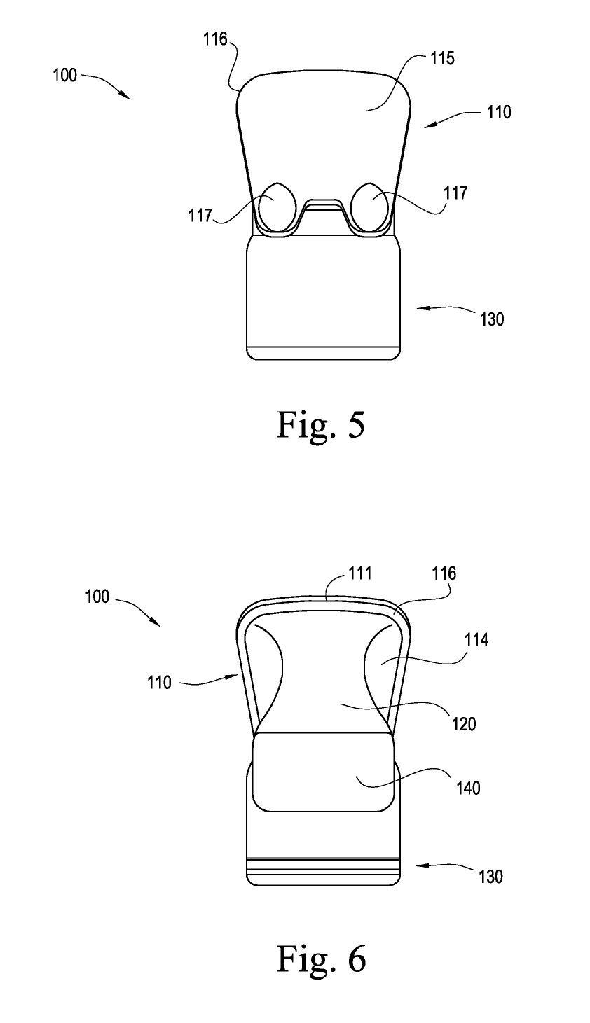

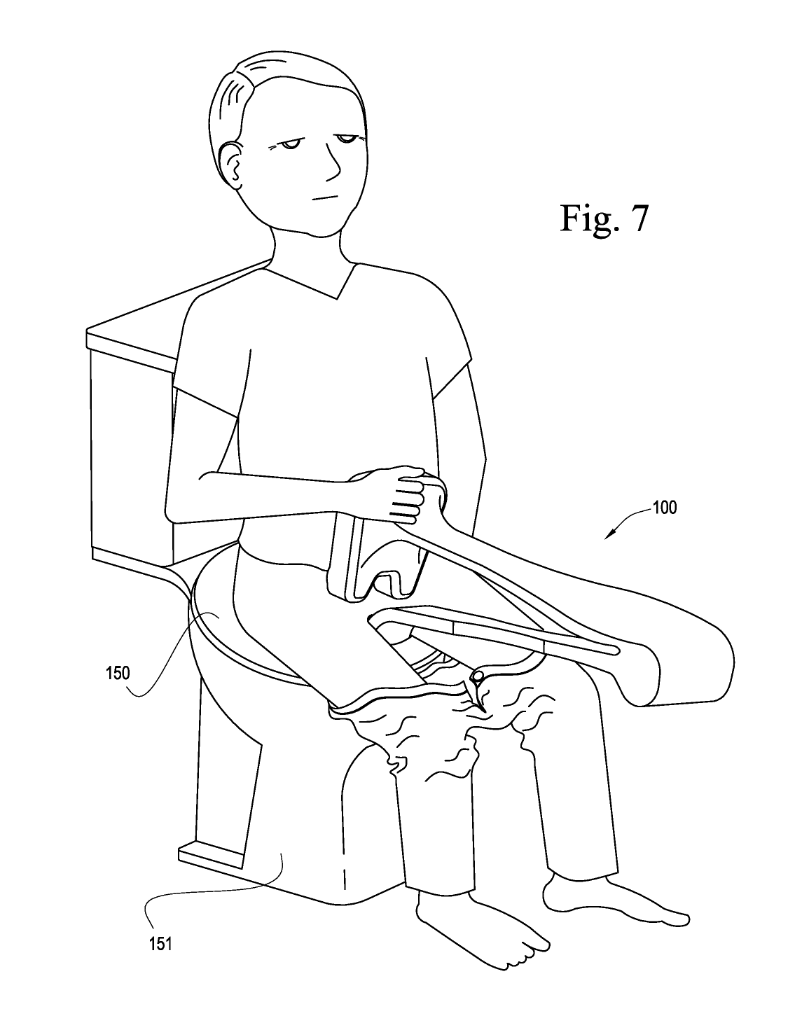

Referring to FIGS. 1-7, an abdominal support apparatus 100 according to an embodiment of the present invention is now described in detail. Throughout this disclosure, the present invention may be referred to as an abdominal support apparatus, a support apparatus, an apparatus, a device, a system, a product, and a method. Those skilled in the art will appreciate that this terminology is only illustrative and does not affect the scope of the invention.

According to an embodiment of the present invention, as depicted, for example, in FIGS. 1-7, an abdominal support apparatus 100 may be adapted to engage a portion of a toilet seat 150, a toilet bowl 151, or a portion of another object or device. The abdominal support apparatus 100 may include a wall member 110, a first lever member 120 that may extend outwardly from the wall member 110, a lever handle member 140 that may connect to the first lever member 120, a second lever member 121 that may connect to and may extend outwardly from the lever handle member 140, and an interior member 130 that may connect to and may extend downwardly from the second lever member 121. The wall member 110, the first lever member 120, the lever handle member 140, the second lever member 121, and the interior member 130 may be integrally formed as a monolithic unit. For example, and without limitation, the abdominal support apparatus 100 may be formed by molding, overmolding, casting, or stamping of a material. Materials may include, without limitation, metals, metal alloys, carbon allotropes, ceramics, polymers, plastics, and composite materials. For example, and also without limitation, any of the molding or overmolding may be accomplished by any process known in the art, including, but not limited to, blow molding, sintering, compression molding, extrusion molding, injection molding, matrix molding, transfer molding, and thermoforming.

For example, and without limitation, any combination of the wall member 110 and the first lever member 120, the first lever member 120 and the lever handle member 140, the lever handle member 140 and the second lever member 121, the second lever member 121 and the interior member, and all other components of the abdominal support apparatus 100 may be connected or attached by glue, adhesives, fasteners, screws, bolts, welding, or any other means or method known in the art. In addition, the connection for any components may be provided by a pivot joint, a ball and socket joint, a rotational joint, a knuckle joint, a turnbuckle, a pin joint, and/or any joint known in the art. The components connected by a joint system may pivot or rotate in numerous directions and at numerous angles and allow the abdominal support apparatus 100 to be adjustable and in numerous configurations.

The abdominal support apparatus 100 may include an angle between the first lever member 120 and the second lever member 121 extending outwardly from the lever handle member 140 between at least 1° and 30°. The wall member 110 may be circular, ovular, or polygonal, including, but not limited to, generally square, rectangular, and trapezoidal. The wall member 110 may include a top portion 111, a bottom portion 112, and opposing side portions 113. In some embodiments, the bottom portion 112 may be generally concave in the direction of the top portion 111. The wall member 110 may further include first and second opposing faces 114, 115 and a rounded edge 116. Furthermore, the first lever member 120 may be adjacent to the first opposing face 114. The second opposing face 115 may include one or more projections 117. The projections 117 may be configured in a variety of shapes, including, but not limited to, a convex shape, a concentric shape, or a shape generally conforming to the contours of a human external abdominal area. For example, and without limitation, the base of the projections 117 may be a tear drop shape and may rise away from the second opposing face 115 in a rounded and decreasing fashion. Those skilled in the art will further appreciate that the angle between the first lever member 120 and the second lever member 121 may be any angle at least greater than 0° and less than 180°. For example, and without limitation, the angle may be 10°.

Those skilled in the art will appreciate that the shape of the wall member 110, including, but not limited to, the top portion 111, the bottom portion 112, the opposing side portions 113, the first opposing face 114, the second opposing face 115, the rounded edge 116, and the projections 117, may be configured to optimally aid a user. For example, and without limitation, the rounded edge 116 may be configured to hinder or prevent pinching or squeezing of adipose tissue. Also for example, and without limitation, the bottom portion 112 may be straight, generally concave, generally convex, or a combination thereof to accommodate the lower body, including the legs and genitalia, of a user. Those skilled in the art will appreciate that the wall member 110 may include any number of rounded edges 116 and/or projections 117 which may be located in any number of locations on or around the wall member 110. For example, and not by means of limitation, the present embodiment of the invention in FIGS. 1-7 includes rounded edges 116 on all edges and corners and two projections 117, each located in the lower corners of the second opposing face 115 of the wall member 110. Those skilled in the art will further appreciate that the projections 117, although depicted in FIGS. 1-9 as protruding from the second opposing face 115, may be projected inward to the wall member 110 generating a cavity or depression in the second opposing face 115 of the wall member 110 or another surface of the wall member 110. Further, although the projections 117 are depicted as being circular in shape, those skilled in the art will appreciate that the projections may have any shape while still accomplishing the goals, features and advantages according to the present invention.

The wall member 110 may also be a bladder or bladder-like device that may be pneumatic. The wall member 110 may be filled with a gas, including, but not limited, to air or compressed air, and may be electronically operated through a nearby electrical outlet connection, a battery or batteries, or another power source (not shown). The wall member 110 may girdle or partially girdle the user's abdominal area or genitalia area.

For example, and without limitation, the design of the wall member 110 may express or reverse errant (reducible) tissue from the inguinal region of a user, hinder entry of migrating intestine, or stabilize a user's abdominal wall. The wall member 110 may accommodate various torso and abdominal area sizes.

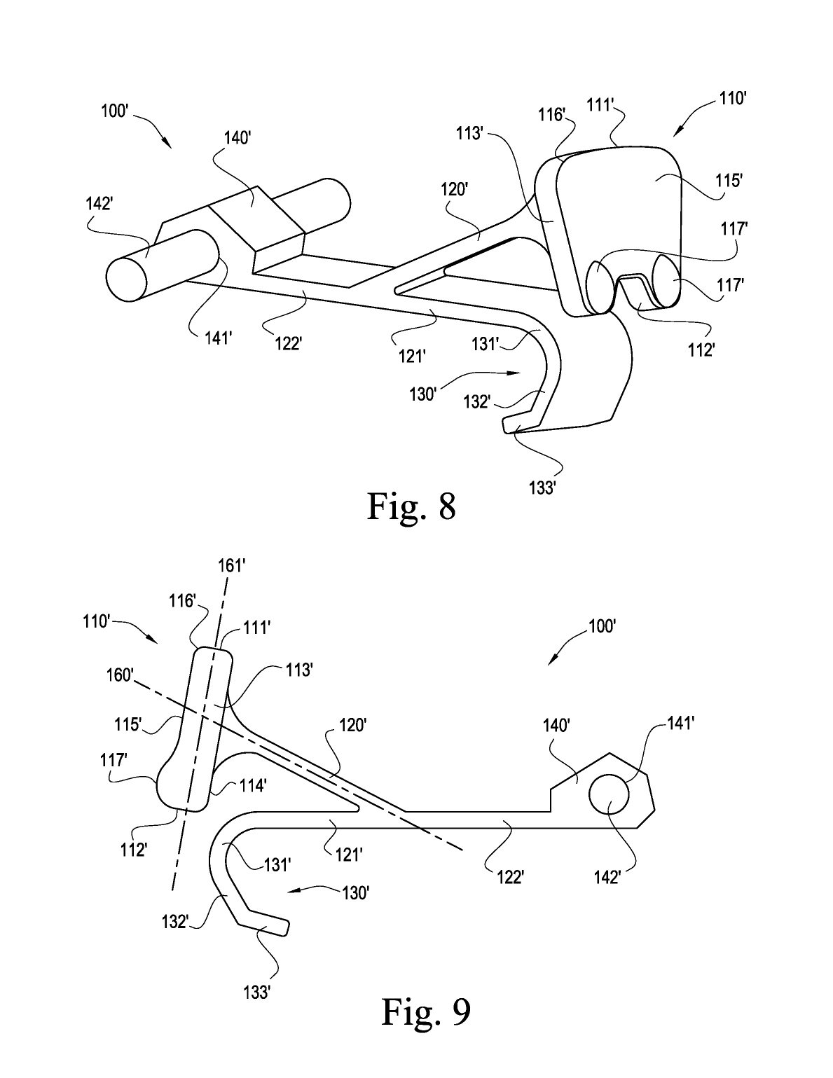

As perhaps best illustrated in FIG. 2, the lever handle member 140 may be configured to function as a counterweight to the wall member 110. The interior member 130 may include a first portion 131 that may connect to the second lever member 121, a second portion 132 that may connect to and may extend downwardly from the first portion 131, and a third portion 133 that may connect to the second portion 132 and may extend inwardly therefrom so that the third portion 133 of the interior member 130 may extend in a direction towards the lever handle member 140. The interior member 130 may be configured to contact an interior portion of the toilet seat 150, an interior portion of the toilet bowl 151, or a portion of another object or device. The first, second, and third portions 131, 132, 133 may be curved. The first, second, and third portions 131, 132, 133 may be different shapes, may be wider or narrower at one end or at both ends, or may include variations in the length, width, or thickness of the first, second, and third portion 131, 132, 133. As illustrated, for example, in the embodiment of the abdominal support apparatus 100′ of FIGS. 8 and 9, the first, second, and third portions 131′, 132′, 133′ may be different shapes, may be wider or narrower at one end or at both ends, or may include variations in the length, width, or thickness between each of the first, second, and third portions.

For example, and without limitation, the first, second, and third portions 131, 132, 133 may be circular, ovular, or polygonal, including, but not limited to, generally square, rectangular, and trapezoidal. Those skilled in the art will appreciate that any number of portions of the interior member 130 may be configured to contact the interior portion of the toilet seat 150, the interior portion of the toilet bowl 151, or a portion of another object or device. For example, and without limitation, FIGS. 1-9 depict the interior member 130 with the first, second, and third portion 131, 132, 133, but the interior member may consist of only the first portion 131 or may consist of four or more portions. The number of portions employed may depend on the desires of the user or may depend upon the toilet seat 150, the toilet bowl 151, or other object or device.

Referring to FIGS. 1-7, those skilled in the art will appreciate that the interior member 130, the first portion, 131, the second portion 132, or the third portion 133 may be of differing lengths and may be adjustable, expandable, or contractible. For example, the first portion 131 may include two sections one of which is smaller than the other and fits within the other so that the smaller section may slide in and out of the larger section. The sliding action may contract or expand the length of the first lever member 120 and may include a locking mechanism to allow the device to lock in a particular position and therefore at a particular length. The contraction or expansion of the interior member 130, the first portion 131, the second portion 132, or the third portion 133 may allow the device to adjust to variously sized toilet seats 150 or toilet bowls 151. Those skilled in the art will appreciate that the interior member 130 and/or the first, second, and/or third portion, 131, 132, 133 may be configured to accommodate all, or nearly all, toilet seat 150 and toilet bowl 151 configurations.

The wall member 110 may be positioned within a range from about 0° to about 45° away from a second axis 161 defined as an axis perpendicular to a first axis 160 defined as a longitudinal axis of the first lever member 120. Those skilled in the art will further appreciate that the wall member 110 may be further positioned any angular distance away from the second axis 161, i.e., any angle between 0° and 360° angularly away from the second axis. For example, and without limitation, the wall member 110 may be positioned within a range from about 0° to about 10° away from the second axis 161, which is positioned substantially perpendicular to the first axis 160 of the first lever member 120. As another example, and also without limitation, the wall member 110 may be angularly positioned about 0° away from the second axis 161, which is positioned substantially perpendicular to the first axis 160 of the first lever member 120. As another example, and further without limitation, the wall member 110 may be positioned about 10° away from the second axis 161, which is positioned substantially perpendicular to the first axis 160 of the first lever member 120.

Referring now to FIGS. 8 and 9, another embodiment of the invention is depicted. The abdominal support apparatus 100′ of FIGS. 8-9 may be generally similar to the abdominal support apparatus 100 as shown in FIGS. 1-7 and as described in the associated description, except to the extent elements thereof are inconsistent with elements of the present embodiment. The abdominal support apparatus 100′ may include a wall member 110′, an interior member 130′, and a lever handle member 140′.

The wall member 110′ may include a top portion 111′, a bottom portion 112′, opposing side sections 113′, a first opposing face 114′, a second opposing face 115′, at least one rounded edge 116′, and one or more projections 117′.

The lever handle member 140′ may include a passageway 141′ that may be formed through a body portion thereof and the passageway 141′ may be adapted to receive a handle member 142′ that may extend therethrough. The handle member 142′ may be formed of a metal, a wood, a fabric, a leather, a plastic, or a foam. Those skilled in the art will appreciate that the handle member 142′ may be formed of any other material suitable for providing support that may be necessary for a user to grasp the handle. The abdominal support apparatus 100′ may include a surface material that may be attached to the lever handle member 140′ and may be more malleable than the surface of the lever handle member 140′. The surface material may provide more friction than the surface of the lever handle member 140′.

As further illustrated in FIGS. 8 and 9, the abdominal support apparatus 100′ according to an embodiment of the present invention may further include a main lever member 122′ that may extend outwardly from the lever handle member 140′ and the first and second lever members 120′, 121′ may extend outwardly from the main lever member 122′. The main lever member 122′ may extend at an angle between at least 1° and 45° away from the first lever member 120′. Those skilled in the art will further appreciate that the angle between the main lever member 122′ and the first lever member 120′ may be any angle at least greater than 0° and less than 180°. For example, and without limitation, the angle may be 20°.

For example, and also without limitation, any combination of the main lever member 122′ and the lever handle member 140′ and the main lever member 122′ and the first and second lever members 120′, 121′ of the abdominal support apparatus 100′ may be connected or attached by glue, adhesives, fasteners, screws, bolts, welding, or any other means known in the art. In addition, the connection for any components may be provided by a pivot joint, a ball and socket joint, a rotational joint, a knuckle joint, a turnbuckle, a pin joint, and/or any joint known in the art. The components connected by a joint system may pivot or rotate in numerous directions and at numerous angles and allow the abdominal support apparatus 100′ to be adjustable and in numerous configurations.

The interior member 130′ may include a first portion 131′ connected to and extending outwardly from the second lever member 121′, a second portion 132′ connected to and extending from the first portion 161′, and a third portion 133′ connected to and extending inward from the second portion 132′.

As also depicted, for example, in FIGS. 8 and 9, the wall member 110′, the first lever member 120′, the lever handle member 140′, the second lever member 121′, the main lever member 122′, and the interior member 130′ may be integrally formed as a monolithic unit. For example, the abdominal support apparatus 100′, including the main lever member 120′, may be formed by molding, overmolding, casting, or stamping of a material. Those skilled in the art will appreciate, however, that the abdominal support apparatus 100′ may be formed by any other known methods suitable for forming such an apparatus. Materials may include, without limitation, metals, metal alloys, carbon allotropes, ceramics, polymers, plastics, and composite materials. For example, and without limitation, any of the molding or overmolding may be accomplished by any molding process known in the art, including, but not limited to blow molding, sintering, compression molding, extrusion molding, injection molding, matrix molding, transfer molding, and thermoforming.

Referring to FIGS. 1-9, when a user desires to apply additional pressure to the user's abdominal area, the user may generate more pressure by applying a lifting or upward force to the lever handle member 140, 140′ or to the handle member 142′. Additionally, the user may apply a downward force to the first lever member 120, 120′, second lever member 121, 121′, or main lever member 122, 122′, which also may apply more pressure to the user's abdominal area. When engaged, the abdominal support apparatus 100, 100′ according to any embodiment of the present invention, may use the toilet seat 150 or toilet bowl 151 as a fulcrum to rotate the abdominal support apparatus 100, 100′ thereby engaging or disengaging the wall member 110, 110′ from the user's abdominal area as desired. For example, and without limitation, the abdominal support apparatus 100, 100′ may optimally apply between zero and forty pounds of force to a user's abdominal area. The pressure may depend upon the size of the user's abdominal area, the size of the wall member 100, 100′, and the amount of force applied to rotate the abdominal support apparatus 100, 100′.

Referring to FIGS. 1-7, for example, and without limitation, a user may engage the lever handle member 140 by placing the user's hand or hands on the sides, bottom, top, or any combination thereof of the lever handle member 140. When a user causes the lever handle member 140 to move in an upward direction, the wall member 110 may engage the user's abdominal area. The more the lever handle member 140 is moved in an upward direction, the more pressure may be applied to the user's abdominal area. Additionally, the user may cause the lever handle member 140 to move in a downward direction, thus the wall member 110 may disengage the user's abdominal area and the less pressure may be applied to the user's abdominal area.

Referring to FIGS. 8 and 9, for example, and without limitation, a user may engage the handle member 142′ by placing the user's hand or hands on the sides, bottom, top, or any combination thereof of the handle member 142′. When a user causes the handle member 142′, and thereby the lever handle member 140′, to move in an upward direction, the wall member 110′ may engage the user's abdominal area. The more the handle member 142′ and the lever handle member 140 are moved in an upward direction, the more pressure may be applied to the user's abdominal area. Additionally, the user may cause the handle member 142′, and thereby the lever handle member 140′, to move in a downward direction, thus the wall member 110′ may disengage the user's abdominal area and the less pressure may be applied to the user's abdominal area.

The abdominal support apparatus 100, 100′ may also employ a gear and lever arm device that would allow a user or other individual to engage or disengage the wall member 110, 110′ thereby increasing or decreasing the amount of pressure applied to the user's abdominal area. For example, a user or other individual may rotate a crank or handle attached to the gear which may cause the wall member 110, 110′ to be directed towards or away from the user's abdominal area.

Referring to FIGS. 1-9, those skilled in the art will appreciate that the first lever member 120, 120′, the second lever member 121, 121′, or the main lever member 122, 122′ may be of differing lengths and may be adjustable, expandable, or contractible. For example, the first lever member 120 may include two sections one of which is smaller than the other and fits within the other so that the smaller section may slide in and out of the larger section. The sliding action may contract or expand the length of the first lever member 120, 120′ and may include a locking mechanism to allow the device to lock in a particular position and therefore at a particular length. The contraction or expansion of the first lever member 120, 120′, the second lever member 121, 121′, or the main lever member 122, 122′ may allow the device to adjust to a user with a larger or smaller torso. The expansion and contraction may better suit the needs or desires of users of different sizes.

Those skilled in the art will appreciate that the various embodiments of an abdominal support apparatus 100, 100′ and the individual components of the abdominal support apparatus 100, 100′ may be any number of sizes, for example, small, medium, or large. The abdominal support apparatus 100, 100′ may portable or may be stationary and may be attached or fastened to a toilet seat 150, toilet bowl 151, or other object or device. The components of the abdominal support apparatus 100 may be removable and may be interchangeable with replacement or upgraded parts. The abdominal support apparatus 100, 100′ or components thereof may include a surface coating. The surface coating may include, without limitation, metals, metal alloys, carbon allotropes, ceramics, polymers, plastics, and composite materials. The abdominal support apparatus 100, 100′ or components thereof may be washable and/or sanitized so that excrement and waste may be removed from the abdominal support apparatus 100.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

1. A dynamic abdominal support apparatus adapted to engage a portion of at least one of a toilet seat, a toilet bowl and a support object, the abdominal support apparatus comprising:
a wall member configured to support a user's abdomen;
a first lever member extending outwardly from the wall member, the first lever member comprising a first end portion coupled to the wall member and a second end portion opposite the first end portion;
a lever handle member coupled to the second end portion of the first lever member;
a second lever member extending inwardly from the first lever member, the second lever member comprising a first end portion coupled to the second end portion of the first lever member and a second end portion opposite the first end portion of the second lever member; and
an interior member coupled to and extending downwardly from the second end portion of the second lever member, the interior member configured to engage the portion of the at least one of the toilet seat, the toilet bowl and the support object.

2. The apparatus according to claim 1 wherein an angle defined between the first lever member and the second lever member is from approximately 1° to approximately 30°.

3. The apparatus according to claim 1 wherein:
the wall member has a shape selected from the group consisting of generally square, rectangular, trapezoidal, circular, and ovular;
the wall member comprises a top portion, a bottom portion, and opposing side portions; and
the bottom portion is generally concave in a direction of the top portion.

4. The apparatus according to claim 3 wherein the wall member comprises a rounded edge.

5. The apparatus according to claim 1 wherein:
the wall member comprises first and second opposing faces, the second opposing face configured to support the user's abdomen;
the first end portion of the first lever member is adjacent to the first opposing face; and
the second opposing face comprises at least one projection.

6. The apparatus according to claim 5 wherein the at least one projection has a shape selected from the group consisting of a convex shape, a symmetric shape, an asymmetric shape, and a shape generally conforming to the contours of a human external abdominal area.

7. The apparatus according to claim 1 wherein the lever handle member is a bulbous member configured to function as a counterweight to the wall member.

8. The apparatus according to claim 1 wherein the interior member comprises:
a first portion coupled to the second end portion of the second lever member,
a second portion coupled to and extending downwardly from the first portion, and
a third portion coupled to the second portion and extending outwardly therefrom such that the third portion of the interior member extends in a direction towards the lever handle member.

9. The apparatus according to claim 8 wherein at least one of the first portion, the second portion, and the third portion is curved.

10. The apparatus according to claim 1 wherein the wall member is positioned within a range from about 0° to about 45° away from a second axis defined as a vertical axis perpendicular to a first axis defined as a longitudinal axis of the first lever member.

11. The apparatus according to claim 1 wherein the wall member is positioned within a range from about 0° to about 10° away from a second axis defined as a vertical axis perpendicular to a first axis defined as a longitudinal axis of the first lever member.

12. The apparatus according to claim 1 further comprising a handle member configured to extend through a passageway in the lever handle member.

13. The apparatus according to claim 12 wherein the handle member is formed of at least one of a metal, a wood, a fabric, a leather, a plastic, and a foam.

14. The apparatus according to claim 1 further comprising a main lever member extending between the lever handle member and the first and second lever members.

15-23. (canceled)

24. The apparatus according to claim 1, wherein at least one of the first lever member and the second lever member has an adjustable length.

25. The apparatus according to claim 1, wherein the first lever member is pivotally coupled to the second lever member such that an angle defined between the first lever member and the second lever member is adjustable.

26. The apparatus according to claim 1, wherein the wall member comprises a bladder.

27. The apparatus according to claim 5, wherein the second opposing face of the wall member faces in a direction away from the lever handle member.

28. A dynamic abdominal support apparatus adapted to engage a portion of at least one of a toilet seat, a toilet bowl and a support object, the abdominal support apparatus comprising:
a wall member configured to support a user's abdomen;
a first lever member extending outwardly from the wall member, the first lever member comprising a first end portion coupled to the wall member and a second end portion opposite the first end portion; and
an interior member coupled to the first lever member, wherein the interior member is configured to engage the portion of the at least one of the toilet seat, the toilet bowl and the support object.

29. The apparatus according to claim 28, further comprising a second lever member extending inwardly from the first lever member, the second lever member comprising a first end portion coupled to the second end portion of the first lever member and a second end portion opposite the first end portion of the second lever member, wherein the interior member extends downwardly and outwardly from the second end portion of the second lever member.

30. The apparatus according to claim 29, wherein an angle defined between the first lever member and the second lever member is from approximately 1° to approximately 30°.

31. The apparatus according to claim 30, wherein the first lever member is pivotally coupled to the second lever member such that the angle defined between the first lever member and the second lever member is adjustable.

32. The apparatus according to claim 29, further comprising a lever handle member coupled to at least one of the second end portion of the first lever member and the first end portion of the second lever member.

33. The apparatus according to claim 32, further comprising a handle member configured to extend through a passageway in the lever handle member.

34. The apparatus according to claim 33, further comprising a main lever member extending between the lever handle member and the first and second lever members.

35. The apparatus according to claim 28, wherein the wall member comprises:
a top portion;
a bottom portion that is generally concave in a direction of the top portion;
opposing side portions;
at least one rounded edge; and
first and second opposing faces, wherein the second opposing face comprises at least one projection configured to engage the user's abdomen.

36. The apparatus according to claim 28, wherein the interior member has an adjustable size to accommodate variously sized toilet seats or toilet bowls.
